(19) United States
(12) Patent Application Publication
(10) Pub. No.: US 2022/0195607 A1
(43) Pub. Date: Jun. 23, 2022

(54) COATING FILM AND COMPOSITE MATERIAL CONTAINING COATING FILM

(71) Applicants: TOYOTA JIDOSHA KABUSHIKI KAISHA, Toyota-shi (JP); NATIONAL INSTITUTE FOR MATERIALS SCIENCE, Tsukuba-shi (JP)

(72) Inventors: Yoshiharu MIYAKE, Miyoshi-shi (JP); Hitoshi ISHII, Chita-shi (JP); Tomohiro MIWA, Toyota-shi (JP); Hiroki NISHIJIMA, Nisshin-shi (JP); Takaaki TANIGUCHI, Tsukuba-shi (JP); Takayoshi SASAKI, Tsukuba-shi (JP); Nobuyuki SAKAI, Tsukuba-shi (JP); Leanddas NURDIWIJAYANTO, Tsukuba-shi (JP); Ai YANAGISAWA, Tsukuba-shi (JP)

(73) Assignees: TOYOTA JIDOSHA KABUSHIKI KAISHA, Toyota-shi (JP); NATIONAL INSTITUTE FOR MATERIALS SCIENCE, Tsukuba-shi (JP)

(21) Appl. No.: 17/529,461

(22) Filed: Nov. 18, 2021

(30) Foreign Application Priority Data
Dec. 21, 2020 (JP) 2020-210927

(51) Int. Cl. C23C 30/00; B05D 1/18; B05D 3/06; B05D 3/10; B05D 7/14; B05D 7/00

(52) U.S. Cl. CPC C23C 30/005; B05D 1/18; B05D 3/067; B05D 2202/10; B05D 3/105; B05D 7/14; B05D 7/51; B05D 3/102

(57) ABSTRACT

A coating film has a multilayer structure including stacked nanosheets of an inorganic oxide and has a thickness of a certain level or more, as well as a composite material containing a metallic material and the coating film provided on the metallic material.

### CROSS-REFERENCE TO RELATED APPLICATION

This application claims priority to Japanese Patent Application No. 2020-210927 filed on Dec. 21, 2020, incorporated herein by reference in its entirety.

### BACKGROUND

### 1. Technical Field

The present disclosure relates to a coating film, in particular, a coating film made of an inorganic oxide, and a composite material containing the coating film.

### 2. Description of Related Art

In the fields of iron and steel, home electric appliances, building materials, automobiles, etc., various metallic materials are required to have corrosion resistance (rust prevention) and coating adhesion. A known technique for providing a metallic material with improved corrosion resistance and an improved rust-preventing effect is incorporation of a large amount of a metallic additive (e.g., Cr) into the metallic material for forming a passive film (metal oxide protective film) on the surface of the metallic material. However, the metallic material containing such a metallic additive has a varied composition and becomes expensive.

Meanwhile, a widely used technique for providing any metallic material with improved corrosion resistance and coating adhesion is chromate treatment of the metallic material. However, the chromate treatment causes a toxicity problem of hexavalent chromium and requires an effluent treatment facility; i.e., this technique has a major environmental problem associated with pollution control. Thus, the chromate treatment has recently been replaced with non-chromium treatment.

For example, Japanese Unexamined Patent Application Publication No. 2006-274385 (JP 2006-274385 A) discloses a rust-preventive coating film composition containing a layered double hydroxide that exfoliates in water and is represented by the general formula: [M²⁺₁₋ₓM³⁺ₓ(OH)₂][G.yH₂O] (wherein M²⁺ is a divalent metal ion selected from Mg, Fe, Zn, Cu, or Co; M³⁺ is a trivalent metal ion selected from Al, Fe, Cr, or In; 0.2≤x≤0.33; G is a Ca, Mg, Zn, Ni, Cu, Co, Mn, Al, Fe, Cr, or Ce salt of a saturated aliphatic monocarboxylic acid having a carbon atom number of up to five; and y is a real number of more than 0).

Japanese Unexamined Patent Application Publication No. 2011-184800 (JP 2011-184800 A) discloses a surface treatment agent containing nanosheets of a crystalline layered inorganic compound made by an organic amine or an organic ammonium compound, the surface treatment agent being characterized in that the organic amine or the organic ammonium compound is a polyfunctional organic amine or a polyfunctional organic ammonium compound.

### SUMMARY

However, according to the coating film and the coting film formation method disclosed in the related arts, a metallic material (i.e., coating target) must be coated with a large amount of a coating material for achieving desired corrosion resistance. This may cause an increase in the thickness of the resultant coating film, leading to an increase in the weight of the metallic material and an increase in production cost.

Aspects of the present disclosure provide a coating film exhibiting high corrosion resistance, and a composite material containing the coating film.

The present inventors have conducted extensive studies on means for solving the aforementioned problems. As a result, the present inventors have found that the corrosion resistance of a metallic material is improved by coating the metallic material with a coating film having a thickness of a certain level or more and having a multilayer structure including stacked inorganic oxide sheets each having a thickness on the order of subnanometers to nanometers.

(1) A first aspect of the present disclosure is directed to a coating film having a multilayer structure including stacked nanosheets of an inorganic oxide, wherein the coating film has a thickness of 20 nm or more, and an interlayer distance between the nanosheets of the inorganic oxide is 1.0 nm or less.

(2) The inorganic oxide may be Ca₂Nb₃O₁₀.

(3) The inorganic oxide may have a perovskite crystal structure.

(4) The inorganic oxide may be titania.

(5) A second aspect of the present disclosure is directed to a composite material containing a metallic material and a coating film provided on the metallic material, wherein the coating film is the aforementioned coating film.

(6) The composite material may have heat resistance.

According to the aspects of the present disclosure, there are provided a coating film exhibiting high corrosion resistance, and a composite material containing the coating film.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a scheme showing a process for degreasing and acid-washing of an SUS material in Comparative Examples and Examples;

FIG. 2 is a scheme showing a process for alternately stacking, by an LBL method, an organic material layer and a titania nanosheet on the degreased and acid-washed SUS material in Comparative Examples and Examples;

FIG. 3 is an AFM image of titania nanosheets in a dispersion used for the production in Comparative Examples and Examples;

FIG. 4 is a TEM image of a cross section of the composite material of Example 1;

FIG. 5 is a graph showing the relationship between the thickness of a coating film and erosion depth after a salt spray test in Comparative Examples 1 to 3 and Examples 1 to 3;

FIG. 6A is a photograph of the SUS material of Comparative Example 1 after a salt spray test;

FIG. 6B is a photograph of the composite material of Example 1 after a salt spray test;

FIG. 7 is a graph showing the relationship between UV irradiation time (horizontal axis), the interlayer distance (spacing) between inorganic oxide nanosheets calculated from the peak position (2θ) derived from a multilayer structure in an XRD diffraction pattern (left vertical axis), and the peak position (2θ) derived from a multilayer structure in an XRD diffraction pattern (right vertical axis) in the composite materials of Comparative Example 4 and Example 4;

FIG. 8 is a graph showing the erosion depths of the composite materials of Comparative Example 4 and Example 4 after a salt spray test;

FIG. 9 is a TEM image of a cross section of the composite material of Example 5;

FIG. 10A is a photograph of the SUS material of Comparative Example 1 after thermal treatment and a salt spray test;

FIG. 10B is a photograph of the composite material of Example 1 after thermal treatment and a salt spray test;

FIG. 10C is a photograph of the composite material of Example 5 after thermal treatment and a salt spray test;

FIG. 10D is a photograph of the composite material of Example 6 after thermal treatment and a salt spray test; and

FIG. 11 is a graph showing the corrosion area percentages of the SUS material of Comparative Example 1 and the composite materials of Examples 1, 5, and 6 after thermal treatment and a salt spray test.

### DETAILED DESCRIPTION OF EMBODIMENTS

An embodiment of the present disclosure will be described below in detail. A coating film and a coating-film-containing composite material of the present disclosure are not limited to the following embodiment, and can be implemented in various forms that may be modified or improved by those skilled in the art without departing from the scope of the present disclosure.

The embodiment of the present disclosure is directed to a coating film having a multilayer structure including stacked nanosheets of an inorganic oxide and having a thickness of a certain level or more, as well as a composite material containing a metallic material and the coating film formed on the metallic material.

Examples of the inorganic oxide include, but are not limited to, titania (titanium oxide) (compositional formula: Ti_{1-d}O₂ (0≤d≤0.50), such as Ti_{0.87}O₂, Ti_{0.91}O₂, or Ti_{1.00}O₂), ruthenium oxide (compositional formula: RuO_{d} (1.8≤d≤2.2), such as RuO₂O_{2.1}), calcium niobate (which may also be referred to as “CNO” in the present specification, etc.) (compositional formula: Ca₂Nb₃O_{z} (9≤z≤10), such as Ca₂Nb₃O₁₀), and spinel (compositional formula: MgAl₂O₄).

The inorganic oxide may be amorphous, crystalline, or a mixture thereof. When, for example, the inorganic oxide is titania, the titania may be amorphous titania, titania having a lepidocrocite structure, titania having an anatase crystal structure, titania having a rutile crystal structure, or a mixture of three or more of these types. When, for example, the inorganic oxide is CNO, the CNO may be amorphous CNO, CNO having a perovskite crystal structure, or a mixture thereof.

Preferably, the inorganic oxide can impart heat resistance to a composite material prepared through formation of a coating film of the inorganic oxide on a metallic material. As used herein, the term “heat resistance” refers to the case where the composite material exhibits superior corrosion resistance even after thermal treatment at a high temperature (generally 300° C. to 500° C., for example, 400° C.) for six hours to 10 hours, for example, eight hours. Examples of such an inorganic oxide include, but are not limited to, CNO and SNO (Sr₂Nb₃O₁₀). The inorganic oxide capable of forming a coating film that imparts heat resistance to the composite material is preferably CNO, particularly preferably CNO having a perovskite crystal structure. When the inorganic oxide is CNO, in particular, CNO having a perovskite crystal structure, the coating-film-containing composite material according to the embodiment of the present disclosure can secure heat resistance (i.e., superior corrosion resistance even after thermal treatment at a high temperature), resulting in a reduction in corrosion area.

As used herein, the term “nanosheets of an inorganic oxide (hereinafter, also referred to as “inorganic oxide nanosheets”)” refers to ultrathin sheets made of an inorganic oxide. The inorganic oxide nanosheets have an average thickness of generally 0.1 nm to 5 nm, preferably 0.5 nm to 3.5 nm. The average of equivalent circle diameters corresponding to the planar dimensions (length and width) of the inorganic oxide nanosheets is generally 0.1 μm to 50 μm, preferably 0.5 μm to 10 μm. Thus, the inorganic oxide nanosheets exhibit high two-dimensional anisotropy. The thickness and planar dimensions of an inorganic oxide nanosheet can be determined by, for example, averaging data obtained at five points of the inorganic oxide nanosheet of interest by use of its atomic force microscope (AFM) photographic image.

The coating film according to the embodiment of the present disclosure has a multilayer structure including stacked inorganic oxide nanosheets. No limitation is imposed on the number of stacked inorganic oxide nanosheets, so long as the thickness of the coating film falls within a thickness range described below. The lower limit of the number is generally three, preferably five, and the upper limit of the number is generally 100, preferably 50.

Since the coating film according to the embodiment of the present disclosure has a multilayer structure including inorganic oxide nanosheets whose number falls within the aforementioned range, the thickness of the coating film can be reduced, and the composite material containing the coating film according to the embodiment of the present disclosure can secure superior corrosion resistance.

The coating film according to the embodiment of the present disclosure has a thickness of 20 nm or more. The thickness of the coating film can be determined by, for example, averaging data obtained at three points of the coating film of interest by use of its transmission electron microscope (TEM) photographic image.

When the thickness of the coating film falls within the aforementioned range, the composite material containing the coating film according to the embodiment of the present disclosure can exhibit controlled erosion (corrosion) depth (i.e., reduced erosion depth) and can secure superior corrosion resistance.

No limitation is imposed on the upper limit of the thickness of the coating film according to the embodiment of the present disclosure. However, an excessively large thickness of the coating film leads to an increase in the weight or cost of the composite material, and easy exfoliation of the coating film. From such a viewpoint, the thickness of the coating film is generally 100 nm, preferably 50 nm.

In the coating film according to the embodiment of the present disclosure, a layer made of an organic material (organic material layer) may be disposed between inorganic oxide nanosheets. In such a case, the coating film according to the embodiment of the present disclosure has a multilayer structure in which inorganic oxide nanosheets and organic material layers are alternately stacked.

Preferably, no organic material layer is disposed between inorganic oxide nanosheets in the coating film according to the embodiment of the present disclosure.

When the coating film according to the embodiment of the present disclosure does not have an organic material layer, inorganic oxide nanosheets are more densely stacked together, and thus the composite material containing the coating film according to the embodiment of the present disclosure can exhibit more controlled erosion depth and can secure more excellent corrosion resistance.

The interlayer distance between inorganic oxide nanosheets (i.e., the interlayer distance between an inorganic oxide nanosheet and the adjacent inorganic oxide nanosheet) is 1.0 nm or less. The interlayer distance between inorganic oxide nanosheets can be calculated as spacing from the peak position (2θ) derived from a multilayer structure in a diffraction pattern of, for example, TEM or X-ray diffractometry (XRD).

When the interlayer distance between inorganic oxide nanosheets falls within the aforementioned range, inorganic oxide nanosheets are more densely stacked together, and thus the composite material containing the coating film according to the embodiment of the present disclosure can exhibit more controlled erosion depth and can secure more excellent corrosion resistance.

The metallic material for forming the coating film according to the embodiment of the present disclosure basically causes no problem, so long as the metallic material is a solid substance stable in an aqueous solution. In principle, no limitation is imposed on the size of the metallic material. Examples of the metallic material include, but are not limited to, metals such as iron and aluminum; and alloys such as stainless steel [SUS material (iron, chromium, and nickel)].

The coating film and the composite material according to the embodiment of the present disclosure can be produced by, for example, the layer-by-layer (LBL) method, which involves repetitions of a process wherein a metallic material from which processing oil and scales have been removed through degreasing and acid-washing is immersed in a suspension containing a dispersed organic material to form an organic material layer, followed by washing and drying; and the resultant product is immersed in a suspension containing dispersed inorganic oxide nanosheets to form a layer of inorganic oxide nanosheets on the organic material layer, followed by washing and drying.

The thickness of the organic material layer or the layer of inorganic oxide nanosheets in the coating film and the composite material according to the embodiment of the present disclosure can be adjusted by controlling, for example, the concentration of the suspension, the immersion time, or the immersion temperature. The overall thickness of the coating film according to the embodiment of the present disclosure can be adjusted by controlling the number of repetitions of the process in the LBL method.

When, for example, the inorganic oxide nanosheets are titania nanosheets in the coating film and the composite material according to the embodiment of the present disclosure, the coating film and the composite material according to the embodiment of the present disclosure can be produced as described below.

Firstly, a metallic material is alternately immersed in a sol containing suspended titania nanosheets and a cationic polymer solution, and this operation is repeated to adsorb a titania nanosheet and a polymer layer onto the metallic material so that each of the nanosheet and the layer has a thickness on the order of subnanometers to nanometers, to thereby form a multilayer film in which the nanosheet and the layer are alternately stacked.

In a practical operation, the metallic material is subjected to an operation cycle including (1) immersion in a titania sol, (2) washing with pure water, (3) immersion in an organic polycation solution, (4) washing with pure water in this order, and this cycle is repeated for required times. The organic polycation is appropriately, for example, polydimethyldiallylammonium chloride (PDDA), polyethyleneimine (PEI), or polyallylamine hydrochloride (PAH).

When the titania nanosheet, which is negatively charged, is used in combination with a positively charged polymer (e.g., polydimethyldiallylammonium chloride (PDDA), polyethyleneimine (PEI), or polyallylamine hydrochloride (PAH)), the nanosheet and the polymer layer can be alternately adsorbed in the form of self-organized monolayers onto the surface of an appropriately treated metallic material. The repetition of this operation can form a titania coating film through the LBL method.

The titania nanosheet, which serves as a raw material for alternate stacking on the metallic material, can be prepared as follows. Specifically, a layered titanium oxide, such as lepidocrocite-type titanate (CsₓTi_{2-x/4}O₄ (wherein 0.5≤x≤1) or AₓTi_{2-x/3}Li_{x/3}O₄ (wherein A=K, Rb, or Cs; 0.5≤x≤1)), trititanate (Na₂Ti₃O₇), tetratitanate (K₂Ti₄O₉), or pentatitanate (Cs₂Ti₅O₁₁) is converted into a hydrogenated substance (HₓTi_{2-x/4}O₄.nH₂O, H_{4x/3}Ti_{2-x/3}O₄.nH₂O, H₂Ti₃O₇.nH₂O, H₂Ti₄O₉.nH₂O, or H₂Ti₅O₁₁.nH₂O), and then the converted substance is shaken in an aqueous solution of, for example, an appropriate amine for single-layer exfoliation.

This chemical treatment for conversion into a hydrogenated substance involves combination of acid treatment and colloid-forming treatment. Specifically, titanium oxide powder having a layered structure is brought into contact with an aqueous solution of an acid (e.g., hydrochloric acid), and the resultant product is subjected to filtration, washing, and then drying. Thus, alkali metal ions present between layers before the treatment are completely replaced with hydrogen ions, to thereby yield a hydrogenated substance.

Subsequently, the resultant hydrogenated substance is added to an aqueous solution of, for example, an amine, and then the mixture is stirred, to thereby yield a sol through colloid formation. In this case, the layers constituting the layered structure are exfoliated one by one. In the sol, the layers (i.e., nanosheets) constituting the crystal matrix are dispersed one by one in water. The thickness of each nanosheet, which depends on the crystal structure of the starting crystal matrix, is very small (i.e., 1 nm or thereabouts). In contrast, the length and the width of each nanosheet are on the order of micrometers; i.e., each nanosheet exhibits very high two-dimensional anisotropy.

Before the layer stacking operation, the surface of the metallic material is cleaned. In general, the metallic material is cleaned with a detergent, degreased with an organic solvent, or cleaned with, for example, concentrated sulfuric acid. Subsequently, the metallic material is immersed in an organic polycation solution, and the polycation is adsorbed onto the metallic material, to thereby positively charge the surface of the metallic material. This operation is necessary for the subsequent stable layer stacking.

Among the aforementioned adsorption cycle process parameters, the concentration of the solution, the pH of the solution, and the immersion time are important for the synthesis of a coating film of good quality. The concentration of the titania sol is preferably 10% by weight or less, particularly preferably 0.5% by weight or less. Since the nanosheets tend to aggregate in an acidic region, the pH of the titania sol is required to be 5 or more, and the pH is preferably 7 or more for stable film formation. Preferably, the concentration of the organic polycation solution is adjusted to 10% by weight or less, and the pH of the organic polycation solution is adjusted to be the same as that of the titania sol. The immersion time is required to be 10 minutes or longer. When the immersion time is shorter than 10 minutes, the surface of a substrate may be insufficiently adsorbed or coated with the nanosheets or the polymer. When the above-described conditions are satisfied, film formation can be performed in a very stable manner.

Even when the inorganic oxide is an inorganic oxide other than the titania nanosheets, the coating film and the composite material according to the embodiment of the present disclosure can be produced by replacing the titania nanosheets with the corresponding inorganic oxide nanosheets in the above-described production method.

When, for example, the inorganic oxide is CNO, a CNO nanosheet that serves as a raw material for alternate stacking on the metallic material can be prepared by converting a layered perovskite oxide (KCa₂Nb₃O₁₀) into a hydrogenated substance (HCa₂Nb₃O₁₀.nH₂O), and then shaking the converted substance in an aqueous solution of, for example, an appropriate amine for single-layer exfoliation.

This chemical treatment for conversion into a hydrogenated substance involves combination of acid treatment and colloid-forming treatment. Specifically, perovskite oxide powder having a layered structure is brought into contact with an aqueous solution of an acid (e.g., hydrochloric acid), and the resultant product is subjected to filtration, washing, and then drying. Thus, alkali metal ions present between layers before the treatment are completely replaced with hydrogen ions, to thereby yield a hydrogenated substance.

Subsequently, the resultant hydrogenated substance is added to an aqueous solution of, for example, an amine, and then the mixture is stirred, to thereby yield a sol through colloid formation. In this case, the layers constituting the layered structure are exfoliated one by one. In the sol, the layers (i.e., nanosheets) constituting the crystal matrix are dispersed one by one in water. The thickness of each nanosheet, which depends on the crystal structure of the starting crystal matrix, is very small (i.e., 1 nm or thereabouts). In contrast, the length and the width of each nanosheet are on the order of micrometers; i.e., each nanosheet exhibits very high two-dimensional anisotropy.

In the thus-produced coating film according to the embodiment of the present disclosure, which has a multilayer structure including stacked inorganic oxide nanosheets, and the composite material containing the coating film, inorganic oxide nanosheets and layers of the polymer (i.e., organic material), which have a thickness on the order of subnanometers, are alternately stacked, and the organic material layers serve as intervening layers.

In the coating film and the composite material according to the embodiment of the present disclosure, the interlayer distance between inorganic oxide nanosheets can be adjusted by, for example, removing a portion or the entirety of the organic material contained in the organic material layers. A portion or the entirety of the organic material contained in the organic material layers can be removed through, for example, (i) treatment with ozone generated by ultraviolet (UV) irradiation (UV treatment) for a predetermined period of time, or (ii) thermal treatment at a temperature at which the organic material is burned out.

The ultraviolet light source to be used may be, for example, a UV lamp, any high-pressure mercury lamp, or a xenon lamp.

The rate of removal of the polymer (i.e., organic material) depends on various parameters, such as the composition and structure of the coating film, ultraviolet intensity, and thermal treatment temperature.

Thus, ultraviolet irradiation conditions in (i) or thermal treatment conditions in (ii) can be set by, for example, determining the interlayer distance between inorganic oxide nanosheets through XRD.

For example, the irradiation in (i) is performed with ultraviolet light having a wavelength of 300 nm or less at an ultraviolet intensity of 1 mWcm⁻² for about 24 hours. The treatment in (i) requires ozone for decomposition of the organic material. However, when the inorganic oxide is titania, ozone is not required to be supplied for the following reason. When titania is irradiated with ultraviolet rays, the organic material is decomposed by the photocatalytic action of titania.

For example, the thermal treatment in (ii) is performed at generally 300° C. to 600° C. for generally 30 minutes to two hours.

The coating film according to the embodiment of the present disclosure can be produced with reference to, for example, Japanese Unexamined Patent Application Publication No. 2001-270022 (JP 2001-270022 A), Japanese Unexamined Patent Application Publication No. 2002-265223 (JP 2002-265223 A), or the literature cited therein.

In the thus-produced coating film and the composite material according to the embodiment of the present disclosure, the formation of the inorganic oxide nanosheets can be followed by various treatments so that the inorganic oxide has a desired crystal structure.

When, for example, the inorganic oxide nanosheets are made of titania in the coating film and the composite material according to the embodiment of the present disclosure, amorphous titania can be converted into titania having an anatase crystal structure through thermal treatment in an inert atmosphere at a temperature of generally 600° C. or higher after formation of the multilayer structure of the inorganic oxide nanosheets. In addition, the titania having an anatase crystal structure can be converted into titania having a rutile crystal structure through thermal treatment at a temperature of 900° C. or higher.

When, for example, the inorganic oxide nanosheets are made of CNO in the coating film and the composite material according to the embodiment of the present disclosure, the treatment in a hydrogen atmosphere at a high temperature (for example, 400° C. to 600° C., for example, 500° C.) (i.e., high-temperature H₂ reduction treatment) can be performed after formation of the multilayer structure of the inorganic oxide nanosheets, to thereby achieve denser bonding of CNO having a perovskite crystal structure while suppressing oxidation of the metallic base material.

The coating film according to the embodiment of the present disclosure is used for coating of a metallic material. Since the metallic material is densely coated with the coating film at a constant thickness, the metallic material can be provided with improved corrosion resistance. Thus, the composite material according to the embodiment of the present disclosure exhibits corrosion resistance, and a component produced from the composite material according to the embodiment of the present disclosure can be restrained from losing its function and deteriorating its appearance due to long-term use.

The present disclosure will next be described by way of some examples, but the present disclosure should not be construed as being limited to the examples.

### I. Corrosion Resistance of Composite Material Containing Coating Film

### I-1. Preparation of Sample

### Comparative Example 1

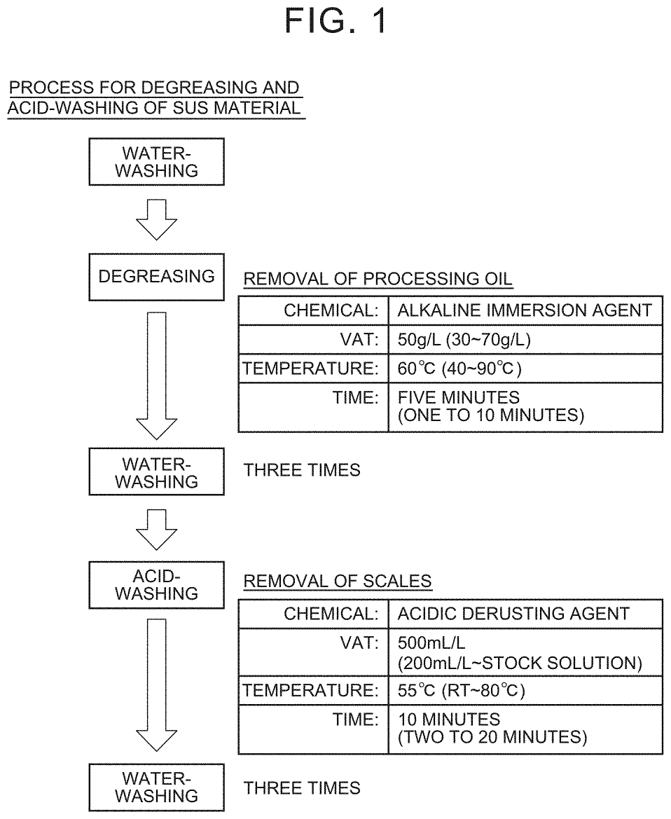

A degreased and acid-washed SUS material was prepared through the process shown in FIG. 1 as described in detail below. Specifically, an SUS material (SUS409) washed with water was immersed in an aqueous detergent solution (the aqueous detergent solution was prepared by mixing water with a grease detergent (alkaline immersion agent) so that the concentration of the grease detergent was adjusted to 50 g/L (generally adjusted to 30 g/L to 70 g/L)) at 60° C. (generally set at 40° C. to 90° C.) for five minutes (generally set for one minute to 10 minutes). The SUS material was then washed with water three times for degreasing (removal of processing oil).

Subsequently, the degreased SUS material was immersed in aqueous detergent solution (the aqueous detergent solution was prepared by mixing water with an acid detergent (acidic derusting agent) so that the concentration of the acid detergent was adjusted to 500 mL/L (generally adjusted to 200 mL/L or more; the acid detergent can be used as it is without being mixed with water)) at 55° C. (generally set at room temperature to 80° C.) for 10 minutes (generally set for two minutes to 20 minutes). The SUS material was then washed with water three times for acid-washing (removal of scales).

### Comparative Example 2

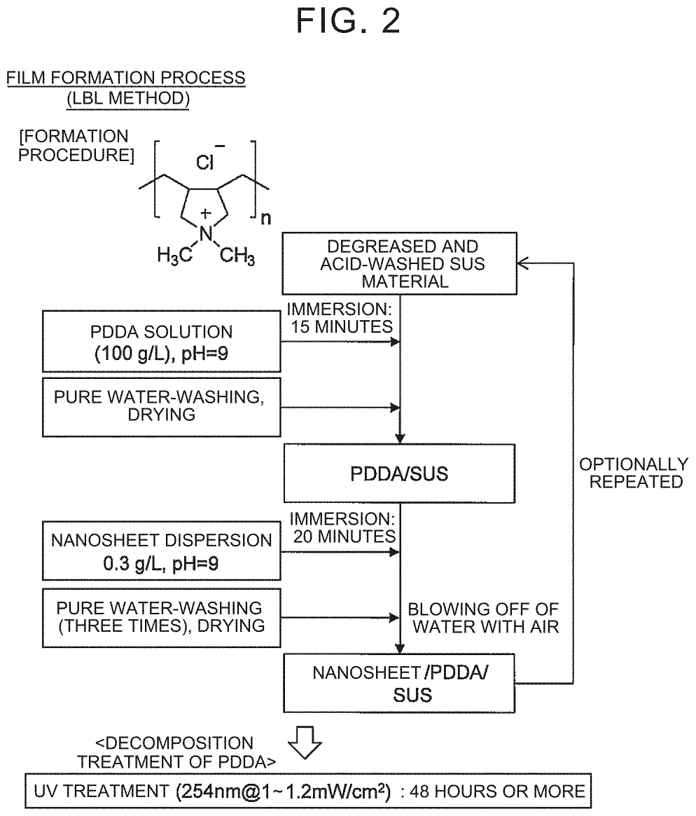

A composite material was produced through the surface treatment (film formation) processes shown in FIGS. 1 and 2 by forming, on an SUS material (i.e., metallic material), a coating film having a multilayer structure including stacked nanosheets of titania (i.e., inorganic oxide) so that the thickness of the coating film was 1 nm. The thickness of the coating film was measured by use of a TEM image. Details will be described below.

Firstly, an SUS material was washed as shown in FIG. 1. Specifically, an SUS material washed with water was immersed in an aqueous detergent solution (the aqueous detergent solution was prepared by mixing water with a grease detergent (alkaline immersion agent) so that the concentration of the grease detergent was adjusted to 50 g/L) at 60° C. for five minutes. The SUS material was then washed with water three times for degreasing.

Subsequently, the degreased SUS material was immersed in aqueous detergent solution (the aqueous detergent solution was prepared by mixing water with an acid detergent (acidic derusting agent) so that the concentration of the acid detergent was adjusted to 500 mL/L) at 55° C. for 10 minutes. The SUS material was then washed with water three times for acid-washing (removal of scales).

Thereafter, as shown in FIG. 2, organic material layers and titania nanosheets were alternately stacked on the degreased and acid-washed SUS material by the LBL method.

Specifically, the degreased and acid-washed SUS material was immersed in a PDDA solution (100 g/L, pH=9) for 15 minutes. Thereafter, the SUS material removed from the PDDA solution was washed with pure water, and high-pressure gas of N₂ or air was sprayed onto the SUS material at room temperature, to thereby yield the SUS material having on its surface a stacked PDDA layer (PDDA/SUS).

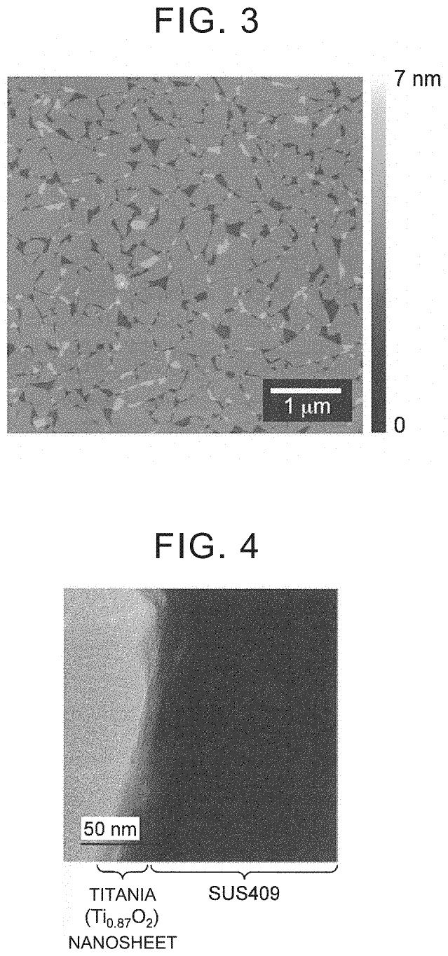

Subsequently, the PDDA/SUS was immersed in a titania nanosheet dispersion (Ti_{0.87}O₂, 0.3 g/L, pH=9) for 20 minutes, and then removed from the titania nanosheet dispersion. The resultant product was washed with pure water three times, and water deposited on the surface was removed by N₂ or air, to thereby yield the SUS material having on its surface stacked PDDA layer and titania nanosheet (titania nanosheet/PDDA/SUS). FIG. 3 shows an AFM image of titania nanosheets in the dispersion.

Finally, the resultant titania nanosheet/PDDA/SUS was subjected to UV treatment through irradiation with UV rays (UV, 254 nm, 1 to 1.2 mW/cm²) for 48 hours or more, to thereby produce a composite material of Comparative Example 2.

### Comparative Example 3

A composite material was produced by forming, on an SUS material, a coating film having a multilayer structure including stacked titania nanosheets so that the thickness of the coating film was 10 nm in the same manner as in Comparative Example 2, except that the process before the UV treatment in the film formation process shown in FIG. 2 (i.e., the process involving immersion of a degreased and acid-washed SUS material in a PDDA solution, washing and drying of the SUS material, immersion of the SUS material in a titania nanosheet dispersion, and then washing and drying of the SUS material) was repeated three times.

### Example 1

A composite material was produced by forming, on an SUS material, a coating film having a multilayer structure including stacked titania nanosheets so that the thickness of the coating film was 20 nm in the same manner as in Comparative Example 2, except that the process before the UV treatment in the film formation process shown in FIG. 2 (i.e., the process involving immersion of a degreased and acid-washed SUS material in a PDDA solution, washing and drying of the SUS material, immersion of the SUS material in a titania nanosheet dispersion, and then washing and drying of the SUS material) was repeated five times. FIG. 4 shows a TEM image of a cross section of the composite material of Example 1.

### Example 2

A composite material was produced by forming, on an SUS material, a coating film having a multilayer structure including stacked titania nanosheets so that the thickness of the coating film was 30 nm in the same manner as in Comparative Example 2, except that the process before the UV treatment in the film formation process shown in FIG. 2 (i.e., the process involving immersion of a degreased and acid-washed SUS material in a PDDA solution, washing and drying of the SUS material, immersion of the SUS material in a titania nanosheet dispersion, and then washing and drying of the SUS material) was repeated 10 times.

### Example 3

A composite material was produced by forming, on an SUS material, a coating film having a multilayer structure including stacked titania nanosheets so that the thickness of the coating film was 40 nm in the same manner as in Comparative Example 2, except that the process before the UV treatment in the film formation process shown in FIG. 2 (i.e., the process involving immersion of a degreased and acid-washed SUS material in a PDDA solution, washing and drying of the SUS material, immersion of the SUS material in a titania nanosheet dispersion, and then washing and drying of the SUS material) was repeated 20 times.

### I-2. Evaluation

Salt Spray Test

A salt spray test was performed on the SUS material of Comparative Example 1, and the composite materials of Comparative Examples 2 and 3 and Examples 1 to 3. The salt spray test involved 20 repetitions of a cycle including spraying of salt water specified by JIS K8150 and drying.

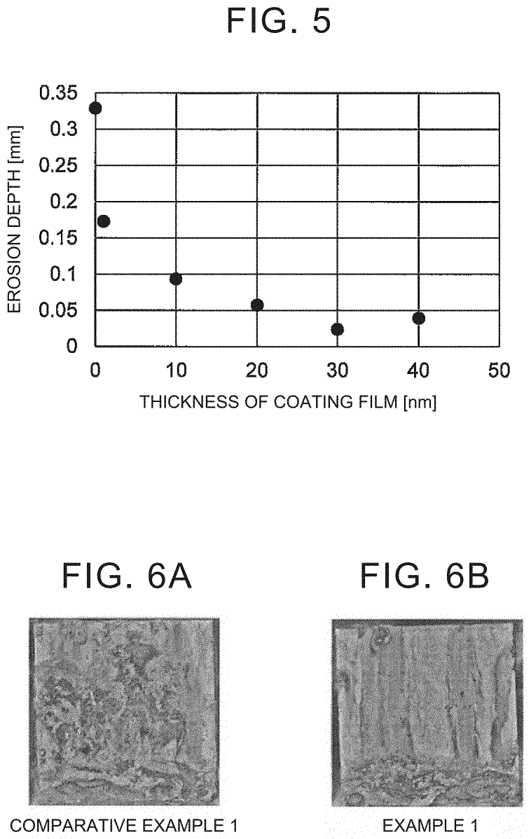

FIG. 5 shows the relationship between the thickness of the coating film and erosion depth after the salt spray test in Comparative Examples 1 to 3 and Examples 1 to 3. As shown in FIG. 5, an increase in the thickness of the coating film led to a decrease in erosion depth. In particular, when the thickness of the coating film was 20 nm or more, the erosion depth was reduced to about 0.05 mm.

FIG. 6A shows a photograph of the SUS material of Comparative Example 1 after the salt spray test. FIG. 6B shows a photograph of the composite material of Example 1 after the salt spray test. As shown in FIGS. 6A and 6B, the composite material of Example 1 exhibited corrosion resistance superior to that of the SUS material of Comparative Example 1.

### II. Effect of Interlayer Distance Between Inorganic Oxide Nanosheets in Coating Film

### II-1. Preparation of Sample

### Comparative Example 4

A composite material was produced by alternately stacking PDDA layers and titania nanosheets on an SUS material in the same manner as in Example 1, except that the UV treatment was omitted in the film formation process shown in FIG. 2.

### Example 4

A composite material was produced by forming, on an SUS material, a coating film having a multilayer structure including stacked titania nanosheets in the same manner as in Example 1.

### II-2. Evaluation

XRD

XRD was performed on the composite materials of Comparative Example 4 and Example 4. XRD of the composite material of Example 4 was also performed after 12-hour UV irradiation and after 24-hour UV irradiation in the UV treatment of the film formation process (composite material production process) shown in FIG. 2.

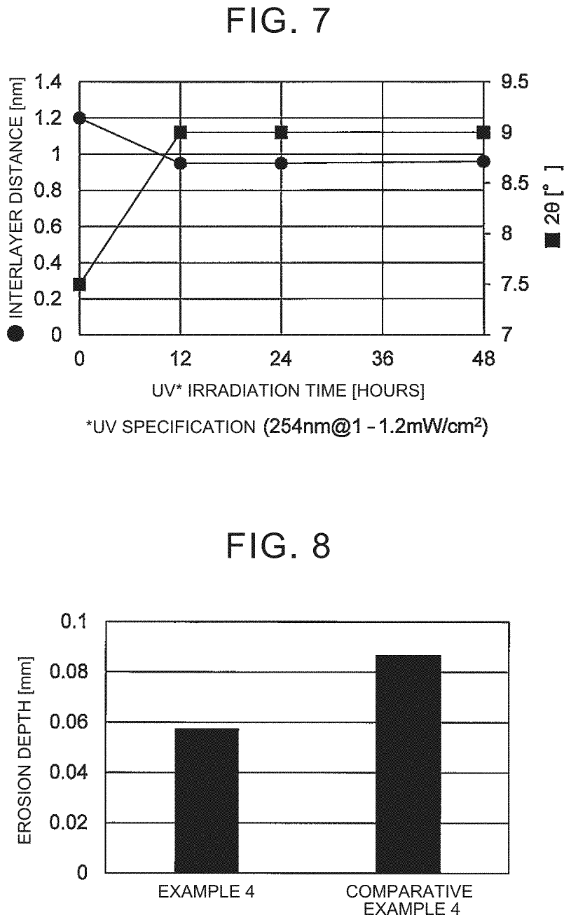

FIG. 7 shows the relationship between UV irradiation time (horizontal axis), the interlayer distance (spacing) between inorganic oxide nanosheets calculated from the peak position (2θ) derived from a multilayer structure in an XRD diffraction pattern (left vertical axis), and the peak position (2θ) derived from a multilayer structure in an XRD diffraction pattern (right vertical axis) in the composite materials of Comparative Example 4 (UV irradiation time: 0 hour) and Example 4 (UV irradiation time: 12 hours, 24 hours, and 48 hours). As shown in FIG. 7, when the UV irradiation time was 12 hours or more, the peak position 2θ derived from a multilayer structure in an XRD diffraction pattern was shifted to a higher angle side, and the interlayer distance (spacing) between inorganic oxide nanosheets was reduced to 1.0 nm or less.

Salt Spray Test

A salt spray test was performed on the composite materials of Comparative Example 4 and Example 4. The salt spray test involved 20 repetitions of a cycle including spraying of salt water specified by JIS K8150 and drying.

FIG. 8 shows the erosion depths of the composite materials of Comparative Example 4 and Example 4 after the salt spray test. As shown in FIG. 8, the erosion depth of the composite material of Example 4 was smaller than that of the composite material of Comparative Example 4. The results indicated that when the interlayer distance between inorganic oxide nanosheets is adjusted to 1.0 nm or less in the composite material, the erosion depth of the composite material can be reduced. This is probably attributed to the fact that an interlayer distance between inorganic oxide nanosheets of 1.0 nm or less causes denser stacking of the inorganic oxide nanosheets, resulting in more improved corrosion resistance of the coating film.

### III. Corrosion Resistance of Composite Material Containing Coating Film after High-Temperature Thermal Treatment

### III-1. Preparation of Sample

### Example 5

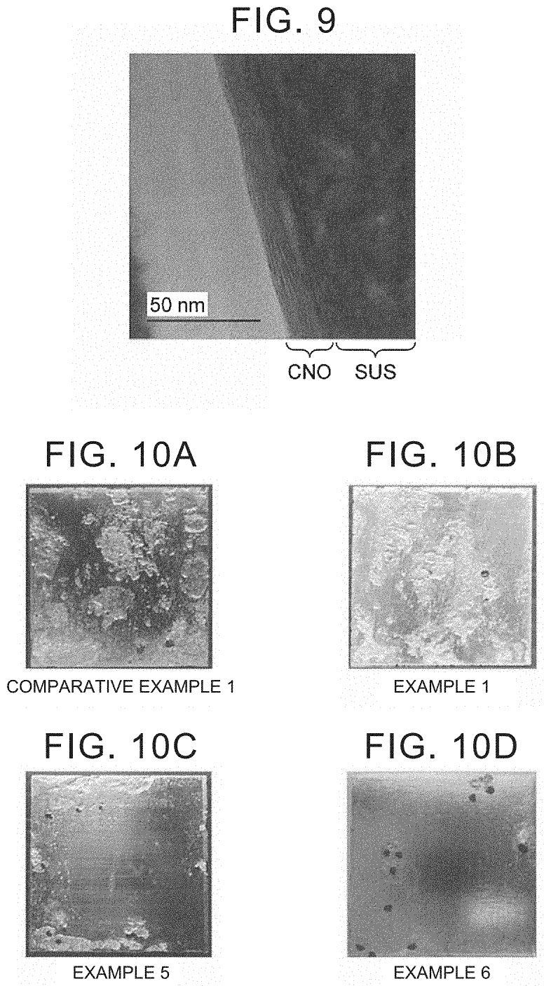

A composite material was produced by forming, on an SUS material, a coating film having a multilayer structure including stacked nanosheets of Ca₂Nb₃O₁₀ having a perovskite crystal structure so that the thickness of the coating film was 20 nm in the same manner as in Example 1, except that the titania nanosheet dispersion (0.3 g/L, pH=9) was replaced with a Ca₂Nb₃O₁₀ nanosheet dispersion (0.3 g/L, pH=9). FIG. 9 shows a TEM image of a cross section of the composite material of Example 5.

The Ca₂Nb₃O₁o nanosheet, serving as a raw material for alternate stacking on the metallic material, was prepared by converting a layered perovskite oxide (KCa₂Nb₃O₁₀) into a hydrogenated substance (HCa₂Nb₃O₁₀.nH₂O), and then shaking the converted substance in an aqueous solution of, for example, an appropriate amine for single-layer exfoliation.

This chemical treatment for conversion into a hydrogenated substance involves combination of acid treatment and colloid-forming treatment. Specifically, perovskite oxide powder having a layered structure was brought into contact with an aqueous solution of an acid (e.g., hydrochloric acid), and the resultant product was subjected to filtration, washing, and then drying. Thus, alkali metal ions present between layers before the treatment were completely replaced with hydrogen ions, to thereby yield a hydrogenated substance.

Subsequently, the resultant hydrogenated substance was added to an aqueous solution of, for example, an amine, and then the mixture was stirred, to thereby yield a sol through colloid formation. In this case, the layers forming the layered structure were exfoliated one by one. In the sol, the layers (i.e., nanosheets) forming the crystal matrix were dispersed one by one in water. The thickness of each nanosheet, which depends on the crystal structure of the starting crystal matrix, was very small (i.e., 1 nm or thereabouts). In contrast, the length and the width of each nanosheet were on the order of micrometers; i.e., each nanosheet exhibited very high two-dimensional anisotropy.

### Example 6

A composite material was produced by forming, on an SUS material, a coating film having a multilayer structure including stacked nanosheets of Ca₂Nb₃O₁₀ having a perovskite crystal structure so that the thickness of the coating film was 20 nm in the same manner as in Example 5, except that the composite material was further subjected to high-temperature H₂ reduction treatment (treatment in a 5% H₂/Ar atmosphere at 500° C. for six hours). The crystal structure of the Ca₂Nb₃O₁₀ nanosheet was determined by XRD.

### III-2. Evaluation

Salt Spray Test after High-Temperature Thermal Treatment

A salt spray test was performed on the SUS material of Comparative Example 1, and the composite materials of Examples 1, 5, and 6 after thermal treatment at 400° C. for eight hours. The salt spray test involved 20 repetitions of a cycle including spraying of salt water specified by JIS K8150 and drying.

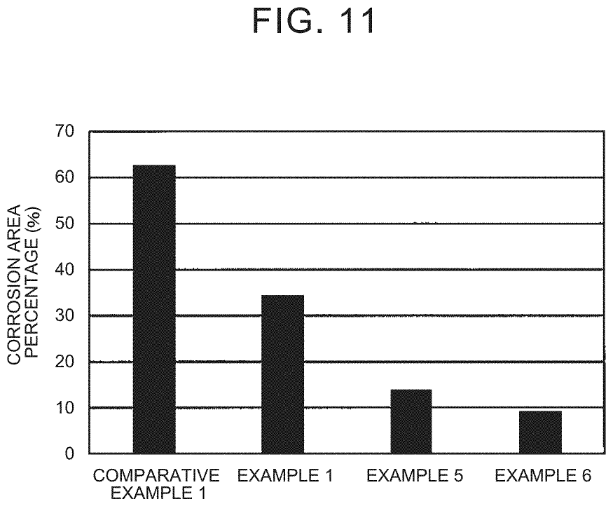

FIGS. 10A to 10D respectively show a photograph of the SUS material of Comparative Example 1, a photograph of the composite material of Example 1, a photograph of the composite material of Example 5, and a photograph of the composite material of Example 6 after the thermal treatment and the salt spray test. FIG. 11 shows the corrosion area percentages of the SUS material of Comparative Example 1 and the composite materials of Examples 1, 5, and 6 after the thermal treatment and the salt spray test. The term “corrosion area percentage” of a sample refers to the percentage of the corroded area of the sample relative to the area of the sample that is sprayed with salt water. As shown in FIGS. 10A to 10D, the composite materials of Examples 5 and 6 exhibited superior corrosion resistance even after the high-temperature thermal treatment, as compared with the SUS material of Comparative Example 1 and the composite material of Example 1. As shown in FIG. 11, the composite material of Example 6 exhibited better corrosion resistance than the composite material of Example 5 even after the high-temperature thermal treatment. As shown in FIG. 11, the corrosion area percentage of Example 1, 5 and 6 is 40% or less. This is probably attributed to the fact that the high-temperature H₂ reduction treatment achieved denser bonding of CNO having a perovskite crystal structure.

What is claimed is:

1. A coating film having a multilayer structure including stacked nanosheets of an inorganic oxide, wherein the coating film has a thickness of 20 nm or more, and an interlayer distance between the nanosheets of the inorganic oxide is 1.0 nm or less.

2. The coating film according to claim 1, wherein the inorganic oxide is Ca₂Nb₃O₁₀.

3. The coating film according to claim 1, wherein the inorganic oxide has a perovskite crystal structure.

4. The coating film according to claim 1, wherein the inorganic oxide is titania.

5. A composite material comprising a metallic material and a coating film provided on the metallic material, wherein the coating film is the coating film according to claim 1.

6. The composite material according to claim 5, wherein the composite material has heat resistance.

7. The composite material according to claim 6, wherein a percentage of a corroded area of the composite material relative to an area of the composite material that is sprayed with salt water is 40% or less after thermal treatment at 400° C. for eight hours.
